(19) United States
(12) Patent Application Publication
(10) Pub. No.: US 2007/0277992 A1
(43) Pub. Date: Dec. 6, 2007

(54) Percussion hand-held power tool with axially displaceable percussion mechanism

(75) Inventor: Josef Fuenfer, Koenigsbrunn (DE)

Correspondence Address: ABELMAN, FRAYNE & SCHWAB, 666 THIRD AVENUE, 10TH FLOOR, NEW YORK, NY, 10017, US

(73) Assignee: HILTI AKTIENGESELLSCHAFT

(21) Appl. No.: 11/807,381

(22) Filed: May 25, 2007

(30) Foreign Application Priority Data
May 30, 2006 (DE) 10 2006 000 253.9

(51) Int. Cl. B25D 11/00

(52) U.S. Cl. 173/210; 173/201; 173/162.1

(57) ABSTRACT

A percussion hand-held power tool includes a housing (4), a chuck (2) provided at one end of the housing (4), a handle (3) provided at an opposite end of the housing (4) and secured thereto, an axially displaceable percussion mechanism (5) located in the housing and connected thereto, at its handle side, by a spring (6) and a transversely extending articulated arm (7), and supported in the housing (4), at its chuck side, by axial slide surface element (8).

### BACKGROUND OF THE INVENTION

1. Field of the Invention

The present invention relates to a percussion hand-held power tool with an axially displaceable percussion mechanism supported in the tool housing and, in particular, to a chisel hammer or a combi-hammer.

2. Description of the Prior Art

In the percussion hand-held power tool of a type discussed above, usually, the percussion mechanism is fixedly secured in the tool housing, so that occurring vibration produced by the percussion mechanism are directly transmitted to the tool housing.

British Publication GB 21 544 97 discloses a hand-held power tool with a percussion mechanism displaceable in the tool housing and supported in the housing by a sliding support at its working tool side and by a rubber guide and an axial spiral compression spring at its handle side.

In the power tool disclosed in WO 9319899, the percussion mechanism is supported at its handle side by a rubber support. With a rubber guide or rubber support, the axial region, within which axial vibrations are generated, is relatively small.

U.S. Pat. No. 4,673,043 discloses a percussion hand-held power tool with an axially displaceable percussion mechanism supported in the housing by two parallelogram hinges. According to German Publication DE 20 109 122 U, the percussion mechanism is connected with the housing by an axial leaf spring. According to German Publication DE 102 55 162, there are provided two transversely extending articulation arms formed of a steel sheet and are provided with foil hinges, and the percussion mechanism is connected with the housing by an axial compression spring. The foregoing support provides for damping of axial vibrations of the housing which are generated in a relatively large axial region.

An object of the present invention is to provide a compact percussion hand-held power tool with a percussion mechanism axially displaceable over relatively large axial region.

### SUMMARY OF THE INVENTION

This and other objects of the present invention, which will become apparent hereinafter, are achieved by providing a percussion hand-held power tool including a housing, a chuck provided at one end of the housing and a handle provided at an opposite end of the housing and secured thereto, and an axially displaceable percussion mechanism located in the housing, with the percussion mechanism being connected, at its handle side, with the housing by a spring and a transversely extending articulated arm and, at its chuck side, being supported in the housing by an axial slide surface element.

The slide support of the percussion mechanism at the mechanism chuck side and an articulated arm provided at the mechanism handle side, insure an axial displacement of the percussion mechanism over a relatively large axial region, simultaneously with a space-saving support of the percussion mechanism at its chuck side, which permits to provide a particularly compact mechanism.

Advantageously, the axial slide surface element is supported in the housing by slide inserts which are formed, advantageously, of a plastic material with intrinsic lubrication means. Thereby, by providing a material pair: metal-plastics, a tribologically with little wear, top position/bottom position characteristic is achieved.

Advantageously, there are provided several identical slide inserts which can easily be mounted and dismounted. This insures their economically favorable storage and an easy replacement in case of wear.

Advantageously, the articulated arm is formed as a leaf spring, advantageously of sheet steel, which permits to economically form it by stamping, while insuring its elasticity and absence of wear.

The spring is advantageously formed as a spiral compression spring which insures as constant as possible spring characteristic over a relatively large axial region, without excessive vibrations.

Advantageously, the percussion mechanism forms part of a rigid module with a drive gear and, further, advantageously with an electric motor. Thereby, the vibrating module or constructional unit has an increased mass, which favors vibration damping.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a partially cross-sectional view of a hand-held power tool according to the present invention; and

FIG. 2 a cross-sectional view along line II-II in FIG. 1.

### DETAILED DESCRIPTION OF THE PREFERRED EMBODIMENTS

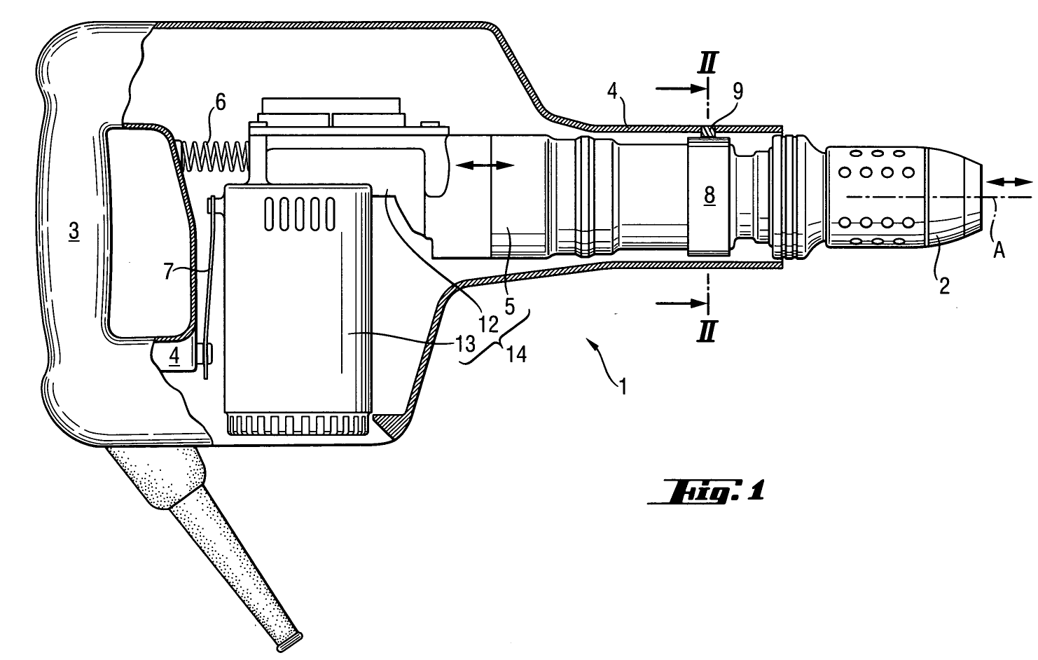

A hand-held power tool 1 according to the present invention, which is shown in FIG. 1 and which applies axial blows along axis A, has a chuck 2 and a handle 3 secured to a housing 4 of the power tool 1. In the housing 4, there is arranged an axially displaceable percussion mechanism 5 which is connected at its handle side with the housing 4 by a spring 6 in form of a spiral compression spring. The percussion mechanism 5 is connected at its handle side with the housing 4 by a transverse articulated arm 7 in form of a leaf spring formed of sheet metal. At its chuck side, the percussion mechanism 5 is supported in the housing 4 by slide inserts 9 that engage an axial slide surface 8 of the percussion mechanism 5. The slide insert 9 is formed of a plastic material with intrinsic lubrication means. The percussion mechanism 5 forms part of a rigid module that includes a drive 12 and an electrical motor 13.

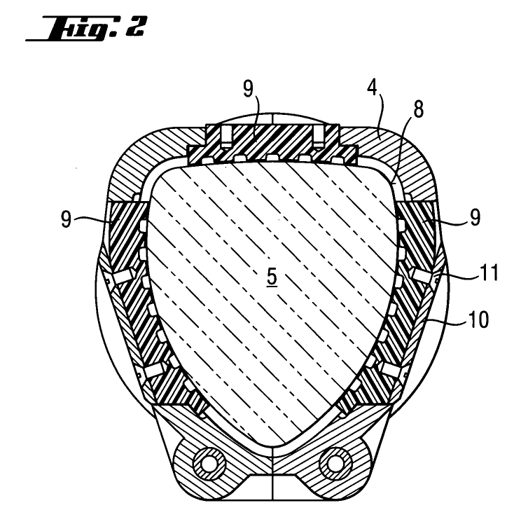

As shown in FIG. 2, the axial slide surface 8 is formed as a convex triangle (without the particularities being shown later) and is supported by three circumferentially distributed slide inserts 9 two of which are identically formed and are mounted each in the housing 4 with the use of a mounting sheet 10 and a screw 11.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A percussion hand-held power tool, comprising a housing (4); a chuck (2) provided at one end of the housing (4); a handle (3) provided at an opposite end of the housing (4) and secured thereto; an axially displaceable percussion mechanism (5) located in the housing; a spring (6) and a transversely extending articulated arm (7) for connecting the percussion mechanism (5) at a handle side thereof with the housing (4); and axial slide surface means (8) for supporting the percussion mechanism (5) at a chuck side thereof in the housing (4).

2. A percussion hand-held power tool according to claim 1, further comprising slide insert means (9) for supporting the slide surface means (8) in the housing (4).

3. A percussion hand-held power tool according to claim 2, wherein the slide insert means (9) comprises a plurality of slide inserts.

4. A percussion hand-held power tool according to claim 1, wherein the articulated arm (7) is formed as a leaf spring.

5. A percussion hand-held power tool according to claim 1, wherein the spring (6) is formed as a spiral compression spring.

6. A percussion hand-held power tool according to claim 1, wherein the percussion mechanism (5) forms part of a module that also includes a drive gear (12).
